(19) United States
(12) Patent Application Publication
(10) Pub. No.: US 2026/0009439 A1
(43) Pub. Date: Jan. 8, 2026

(54) BRAKE ACTUATOR AND METHOD FOR OPERATING A BRAKE ACTUATOR

(71) Applicant: ZF Active Safety GmbH, Koblenz (DE)

(72) Inventors: Roman Bechmann, Koblenz (DE); Marcus Janson, Koblenz (DE)

(21) Appl. No.: 19/257,579

(22) Filed: Jul. 2, 2025

(30) Foreign Application Priority Data
Jul. 4, 2024 (DE) 102024118970.3

(51) Int. Cl. F16D 65/18; B60T 13/74; F16D 55/226; F16D 121/24; F16D 125/40; F16D 125/52; F16D 127/06

(52) U.S. Cl. CPC F16D 65/18; B60T 13/746; F16D 55/226; F16D 2121/24; F16D 2125/40; F16D 2125/52; F16D 2127/06

(57) ABSTRACT

A brake actuator for an electromechanical vehicle brake has a locking assembly (40) for selectively rotationally blocking an output shaft (42) to form a parking brake function. The locking assembly (40) comprises a wrap spring (44) and a drive (70), wherein the windings (46) of the wrap spring (44) are arranged coaxially with the output shaft (42) and the locking assembly (40) is configured and arranged such that the drive (70) can tighten the wrap spring (44) about the output shaft (42) into a locked position in order to block the output shaft (42). After the electromechanical vehicle brake (10) is closed, the wrap spring (44) is tightened into the locked position so that the output shaft (42) is blocked. For a hot retensioning of the vehicle brake, the output shaft (42) is rotated in a rotational direction increasing the brake force, whereby the wrap spring (44) is loosened. The vehicle brake is reset in the rotational direction increasing the brake force and the output shaft (42) is released again, whereby the wrap spring (44) is tightened again.

### TECHNICAL FIELD

The invention relates to a brake actuator for an electromechanical vehicle brake and a method for operating a brake actuator.

### BACKGROUND

Brake actuators are used in vehicle brakes in order to apply a brake pad to a brake rotor. To this end, the brake actuator generally has an electric motor which is coupled in terms of drive via a gear unit and a spindle drive to an actuating carriage which can be selectively moved between a retracted position and an extended position in order to apply the brake pad to the brake rotor. In particular, an axial feed force is transferred from the actuating carriage to the brake pad in order to apply the brake pad to the brake rotor.

If the vehicle brake is used as a service brake, it is configured to be self-releasing. If the electromechanical vehicle brake is also intended to function as a parking brake, in addition to its function as a service brake, generally a locking mechanism which prevents an automatic release of the vehicle brake is provided for implementing a parking brake function.

### SUMMARY

It is an object of the present invention to provide a brake actuator by which the functionality of an electromechanical vehicle brake can be even further increased.

This object is achieved by a brake actuator for an electromechanical vehicle brake which has an electric motor for actuating the vehicle brake and a locking assembly for selectively rotationally blocking an output shaft of the electric motor to form a parking brake function, wherein the locking assembly comprises a wrap spring and a drive, the windings of the wrap spring being arranged coaxially with the output shaft and the locking assembly being configured and arranged such that the drive can tighten the wrap spring about the output shaft into a locked position in order to block the output shaft.

For activating the parking brake function, the drive is actuated after the vehicle brake is closed, whereby a pulling force acts on the ends of the wrap spring and the wrap spring is tightened into its locked position. As a result, the friction between the windings of the wrap spring and the output shaft increases to a sufficient extent that a rotation of the output shaft is completely prevented at least in a direction releasing the brake force. Thus the vehicle brake is locked in its closed position.

For releasing the parking brake function, the pulling force on the ends of the wrap spring is reduced. The windings of the wrap spring are radially expanded again until a release position of the wrap spring is reached, in which the frictional forces are sufficiently reduced that the output shaft can freely rotate in both rotational directions.

Advantageously the blocking of the output shaft takes place exclusively by the increased friction which is caused by tightening the wrap spring. Further mechanically moved elements, such as a carriage or locking pawl, can be dispensed with. This reduces the space requirement and the costs for the locking assembly.

It has been shown that with a wrap spring having approximately 3 to 12 windings, the output shaft can be sufficiently blocked when a moderate force is applied by the drive. Wrap springs with more windings or fewer windings are also conceivable, however.

Preferably, the wrap spring consists of a spring wire. This has the advantage that the wrap spring is urged to open without the application of a load. Thus a normally open spring can be produced, so to speak. If the pulling force is removed, the windings of the wrap spring are expanded until it is in the release position, without requiring further mechanical action therefor.

The wrap spring preferably adopts a larger first diameter in a release position without the action of a pulling force, and a smaller second diameter in the locked position with the action of a pulling force, wherein the output shaft can rotate unhindered in the release position of the wrap spring and is completely locked in the locked position of the wrap spring at least in the rotational direction releasing the brake force. In normal operation of the vehicle brake as a service brake, no appreciable frictional forces act between the output shaft and the wrap spring.

In order to achieve an action of force which is as direct as possible on the output shaft, the wrap spring can be wrapped around an outer surface of a component which is directly arranged on the output shaft. Thus a very compact locking assembly can also be implemented. The component is preferably connected fixedly in terms of rotation to the output shaft. The component has, in particular, a smooth outer surface on which the windings of the wrap spring directly bear. Thus the friction is reduced as far as possible in the release position.

The outer surface of the component is, in particular, circular cylindrical.

The diameter of the outer surface can be adapted within the knowledge of a person skilled in the art to the current conditions, amongst other things regarding the force to be applied, the number of windings, the thickness and the material of the wrap spring.

The component is, for example, sleeve-shaped or bell-shaped.

In a preferred variant, the component is axially positively connected to a drive pinion arranged on the output shaft for driving the vehicle brake. The output pinion is normally provided to couple the electric motor to a gear unit of the brake actuator and thus to provide the drive force for actuating the vehicle brake. The positive connection can be achieved, for example, by an inner toothing on the component which is adapted to an outer toothing of the drive pinion and into which the outer toothing of the drive pinion engages.

The component can be placed at any suitable point on the output shaft. It is possible, for example, to arrange the component on the side of the drive pinion remote from the motor in order to utilize the available space in the brake actuator more effectively.

It is also conceivable to integrate the component in the output shaft in one piece.

In order to tighten the wrap spring and to open it again in a controlled manner, advantageously a first end of the wrap spring is fixedly connected to the output shaft, in particular the component. The connection, for example, can be implemented positively and/or non-positively. For example, the first end of the wrap spring is inserted and/or clamped in a recess on a side wall of the component.

Preferably, both ends of the wrap spring are securely fixed so that the drive always brings about a controlled pulling force and thereby a controlled reduction in the diameter of the windings of the wrap spring.

Preferably, a drive part, which is moved by the drive and to which the second end of the wrap spring is fixed, is provided for transferring the force from the drive to the wrap spring. By actuating the drive, the path between the second end of the wrap spring and the windings is lengthened and thus the wrap spring is tightened.

For example, the locking assembly can comprise a rotatable drive part which is fixedly connected to a second end of the wrap spring and which is rotated by the drive in order to tighten the wrap spring.

A centre axis of rotation of the drive part is preferably parallel to the output shaft of the electric motor.

Alternatively the drive and the drive part can also be designed such that the drive part is moved in a linear manner in order to apply the required tension onto the wrap spring.

The second end of the wrap spring can be positively and/or non-positively secured, in a similar manner to the first end thereof, for example by being inserted into a recess in a side wall or a lower face of the drive part and/or clamped therein.

The drive part is arranged, for example, radially and axially adjacent to the component so that the force can be transferred to the wrap spring as perpendicularly as possible to the axis of the windings. This increases the control of the tightening and opening of the wrap spring.

The locking assembly can have an electric motor as a drive and a worm wheel coupled to the shaft of the electric motor, wherein the drive part has a toothing which is coupled to the worm wheel. Preferably, the worm wheel is directly arranged on the shaft of the electric motor and meshes directly with the toothing of the drive part. This toothing is configured in this case as a helical toothing.

Generally a rotation of the drive part by less than 360° is sufficient in order to tighten the wrap spring from the release position into the locked position.

If the drive part is rotated by less than 360°, it is sufficient to configure the toothing on the periphery of the drive part only in the angular range which is actually required between the release position and the locked position. This makes the locking assembly more compact and saves costs.

The electric motor serving as a drive is a separate motor from the electric motor which actuates the vehicle brake. It can also be designed to be significantly smaller and less powerful than this motor, since its only task is to move the drive part and to tighten the wrap spring into the locked position.

The worm gear is normally self-locking so that even when the drive of the locking assembly is switched off the pulling force on the wrap spring is maintained and the output shaft remains securely locked against a release of the parking brake. Thus an energizing of the drive can be dispensed with in the locked position, which contributes to an energy-efficient operation of the brake actuator.

It is possible to provide an electronic detection apparatus for detecting the locked position and/or the release position of the wrap spring. To this end, for example, it is possible to use a system for monitoring the motor current of the electric motor of the locking assembly. Since the locked position of the wrap spring is determined by the frictional force generated by the wrap spring, the requirements for positioning the shaft of the electric motor, however, are low, which simplifies the monitoring.

The drive part can be rotatably mounted on a frame part of the brake actuator or on another part of an actuator housing. For example, a pin which is rotatably mounted in a suitable recess in the frame part extends along a centre axis of rotation of the drive part.

The drive, in particular the electric motor, and the drive part of the locking assembly are preferably also fixed to the frame part. The forces occurring when tightening the wrap spring are thus diverted into the load-bearing parts of the brake actuator.

For reducing the loss of power and providing redundancy, in one variant two wrap springs are arranged parallel to one another along an axis of rotation of the output shaft. Both wrap springs can thus be configured, arranged and fixed as described above. Preferably, both wrap springs have the same winding direction.

The winding direction of the wrap spring relative to the output shaft is advantageously selected such that in the locked position the wrap spring is expanded by a rotation of the output shaft in a rotational direction increasing the brake force and is tightened again in an opposing rotational direction releasing the brake force. This firstly provides additional safety for the parking brake function and secondly permits a simple hot retensioning of the vehicle brake (also denoted as a “hot reclamp”).

The hot retensioning of the electromechanical vehicle brake is used in order to compensate for a decrease in the tensioning force when the vehicle brake cools down.

In the locked position, a high frictional force acts between the wrap spring and the output shaft. A rotation of the output shaft and thus of the component thus acts directly on the wrap spring.

If the wrap spring is in the locked position and the electric motor of the vehicle brake rotates the output shaft in the rotational direction increasing the brake force, therefore, in an above-mentioned type of winding of the wrap spring, the windings of the wrap spring are slightly radially expanded, i.e. the wrap spring is slightly loosened.

This expansion is sufficient in order to permit a rotation of the output shaft for retensioning the vehicle brake relative to the reduced frictional force of the wrap spring.

Once the retensioning is completed, the electric motor is switched off again. Since the vehicle brake is self-releasing, the rotational direction of the output shaft changes into the opposing direction. However, this leads to the wrap spring, which still bears against the component with sufficient friction and thus is still frictionally coupled to the output shaft, now being rotated in the rotational direction releasing the brake force. However, in this direction the wrap spring is tightened due to its type of winding.

Since before the start of the retensioning the wrap spring was tightened in the locked position, it adopts its locked position again since the drive of the locking assembly has not been actuated. Thus the output shaft is blocked again immediately after the end of the retensioning. The rotational angle required for the renewed tightening of the wrap spring is not important for practical reasons.

An actuation of the drive of the locking assembly and further mechanical components are not required for implementing the hot retensioning function.

The electric motor of the electromechanical vehicle brake is preferably, as known, coupled in terms of drive via a gear unit and a spindle drive to an actuating carriage which can be selectively moved between a retracted position and an extended position in order to apply a brake pad to a brake rotor. Thus a rotation of the output shaft of the electric motor can be transferred into a linear movement of the actuating carriage, whereby an axial feed force is produced in order to apply the brake pad to the brake rotor.

If such an electromechanical vehicle brake is used as a service brake in order to decelerate a vehicle during normal vehicle operation, the drive of the locking assembly is not actuated. Only when the vehicle brake is to be used as a parking brake is the output shaft locked in the closed position by the locking assembly after the brake pad is applied to the brake rotor, by the wrap spring being tightened. For releasing the parking brake, the wrap spring is released again by the drive and returns into the release position.

The above-mentioned object is also achieved by a method for operating a brake actuator of an electromechanical vehicle brake as has been described above. The method has the following steps:
closing the electromechanical vehicle brake,
activating the drive and tightening the wrap spring as far as the locked position so that the output shaft is blocked,
rotating the output shaft by the electric motor in a rotational direction increasing the brake force, whereby the wrap spring is loosened,
re-setting the vehicle brake by the electric motor in the rotational direction increasing the brake force, and
releasing the output shaft by switching off the electric motor, whereby the wrap spring is tightened again.

Thus a hot retensioning is possible in a simple manner without activating the drive of the locking assembly, while an inadvertent release of the parking brake function and the vehicle brake is still securely prevented.

### BRIEF DESCRIPTION OF THE DRAWINGS

The invention is described hereinafter in more detail by way of several exemplary embodiments with reference to the accompanying figures. In the figures:

FIGS. 1 and 2 show a vehicle brake with a brake actuator according to the invention in a schematic perspective view and in a sectional view;

FIG. 3 shows a schematic perspective view of a locking assembly of a brake actuator according to the invention according to a first variant;

FIG. 4 shows an exploded view of the locking assembly of FIG. 3;

FIGS. 5 and 6 show detailed views of the locking assembly of FIG. 3;

FIG. 7 shows a plan view of the locking assembly of FIG. 3;

FIG. 8 shows a sectional view of the locking assembly of FIG. 7;

FIGS. 9 to 13 show schematic views of the functional principle of a wrap spring; and

FIG. 14 shows a schematic view of a locking assembly of a brake actuator according to the invention with two wrap springs according to a second variant.

### DESCRIPTION

For reasons of clarity, not all of the identical parts are always provided with reference signs. The same reference signs in different variants denote identical or substantially identical or similar-acting parts and components.

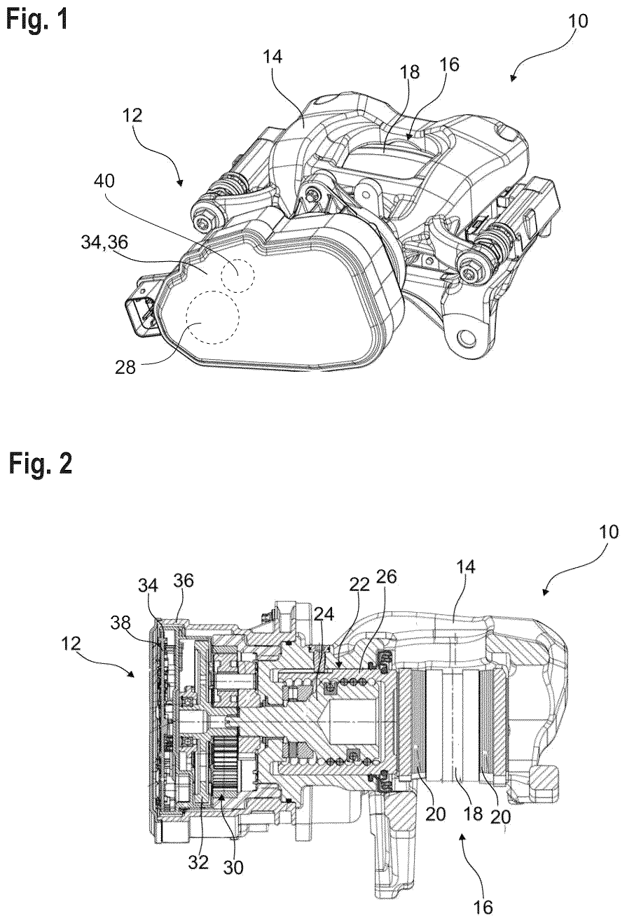

FIGS. 1 and 2 show an electromechanical vehicle brake 10 with a brake actuator 12 in a perspective view and in a sectional view.

In this example, the vehicle brake 10 is used as a service brake of a vehicle. This means that the vehicle brake 10 serves for braking the vehicle in normal driving mode. In addition, the vehicle brake 10 has a parking brake function which thus also serves for locking the parked vehicle in position.

The brake actuator 12 comprises a brake calliper 14 in which an intermediate space 16 is formed for a brake rotor 18. A brake pad 20 (see FIG. 2) which can be applied to the brake rotor 18 is arranged in the intermediate space 16.

The brake actuator 12 also comprises a spindle drive 22 which in the exemplary embodiment is a ball screw drive with a rotatably mounted spindle 24 which is driven by motor and on which an actuating carriage 26 is mounted. The spindle 24 serves for axially moving the actuating carriage 26. The actuating carriage 26 forms the spindle nut of the spindle drive 22. In practice, the actuating carriage 26 represents a brake piston. The actuating carriage 26 is selectively movable by axial displacement between an extended and a retracted position in order to apply the brake pad 20 to the brake rotor 18. In the extended position, the actuating carriage 26 pushes against the brake pad 20 and transfers an axial feed force to the brake pad 20.

The brake actuator 12 also comprises an electric motor 28 (indicated in FIG. 1) for actuating the vehicle brake 10.

In addition, the brake actuator 12 comprises a gear unit 30.

The electric motor 28 is coupled in terms of drive via the gear unit 30 and the spindle drive 22 to the actuating carriage 26, in order to move the actuating carriage 26 between the retracted position and the extended position.

The gear unit 30 is mounted on a frame part 32 of a housing of the brake actuator 12. The frame part 32 absorbs all of the reaction forces and reaction torques which occur when actuating the vehicle brake 10 and diverts them into the brake calliper 14.

For activating the electric motor 28, the brake actuator 12 comprises an electronics unit 34 which is accommodated in an electronics housing 36. The electronics unit 34 in the exemplary embodiment is a printed circuit board 38 as can be seen in FIG. 2. The electronic parts required for activating the electric motor 28 are arranged on the printed circuit board 38.

Since the vehicle brake 10 is configured as a service brake it is self-releasing. This means that as soon as the electric motor 28 is not active in normal driving mode, the actuating carriage 26 can move and be released from the brake pad 20.

In order to implement the additional parking brake function, the brake actuator 12 has a locking assembly 40 for selectively rotationally blocking an output shaft 42 of the electric motor 28.

The locking assembly 40 comprises a wrap spring 44 which is arranged coaxially with the output shaft 42.

The wrap spring 44 can be tightened into a locked position in which the output shaft 42 is blocked at least in a rotational direction increasing the brake force. If the wrap spring 44 is released, it adopts a release position in which the output shaft 42 can rotate unhindered by the wrap spring 44 in both rotational directions.

In this example, the wrap spring 44 is wound with a plurality of windings 46 (for example 3 to 10) about a component 48 which is mounted fixedly in terms of rotation on the output shaft 42 coaxially with an axis of rotation AB of the output shaft 42.

The component 48 has a circular cylindrical and, in particular, smooth outer surface 50 which extends in the axial direction over all of the windings 46 of the wrap spring 44.

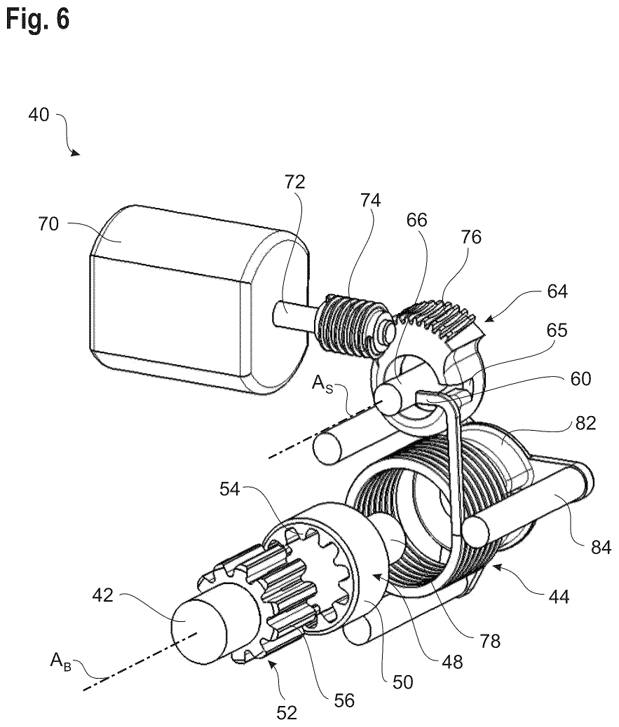

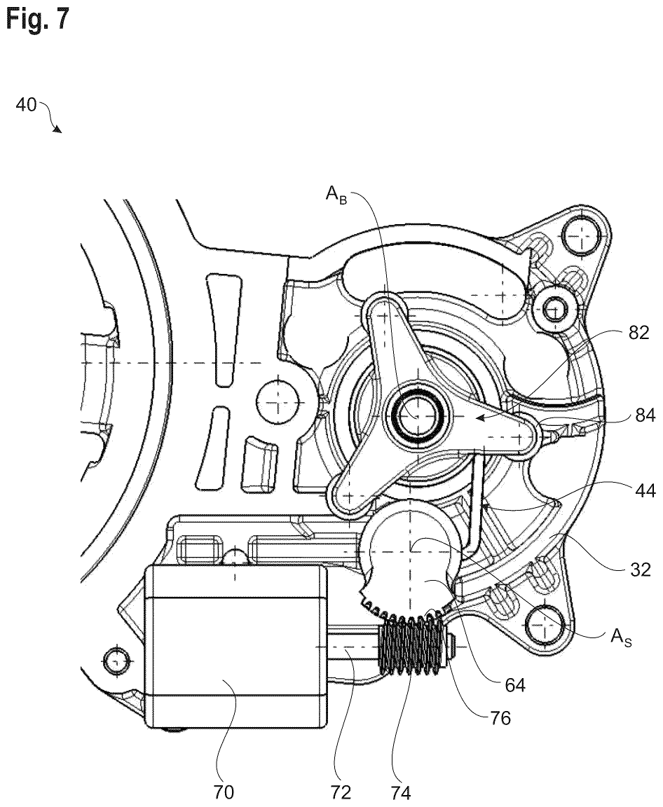

In this example, the component 48 is bell-shaped and in this case axially positively connected to a drive pinion 52 on the output shaft 42. An inner toothing 54 of the component 48 is positioned to this end on an outer toothing 56 of the drive pinion 52 (see FIG. 6).

The component 48 is positioned on the side of the drive pinion 52 remote from the motor.

The component 48 leaves a sufficient portion of the outer toothing 56 axially free so that the drive pinion 52 can be coupled to the gear unit 30, in order to transfer the drive force of the electric motor 28 to the spindle drive 22.

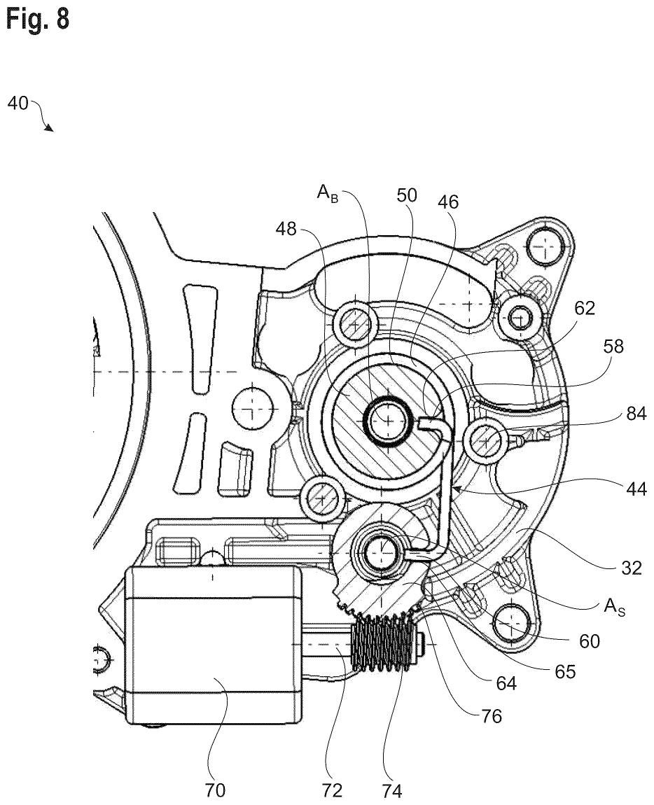

The wrap spring 44 has a first free end 58 and a second free end 60 (see for example FIGS. 8 and 6) between which the windings 46 are located.

The first free end 58 is secured to the component 48 and thus connected fixedly in terms of rotation to the output shaft 42. In this example, the first end 58 is positively and/or non-positively received in a radial recess 62 in the outer surface 50 (see FIG. 8).

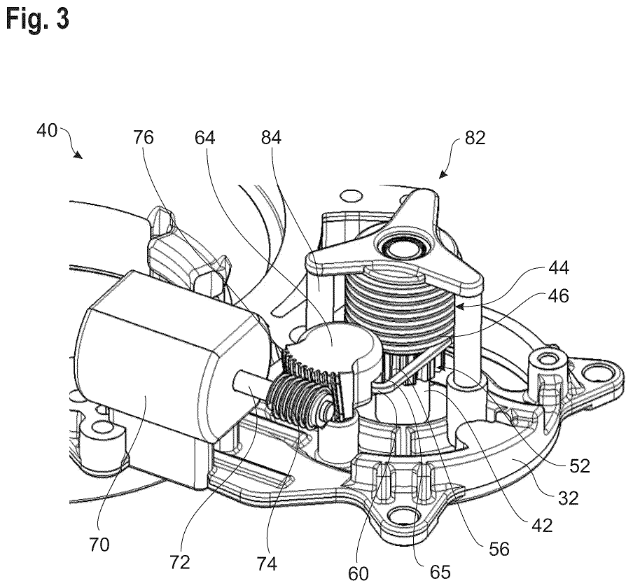

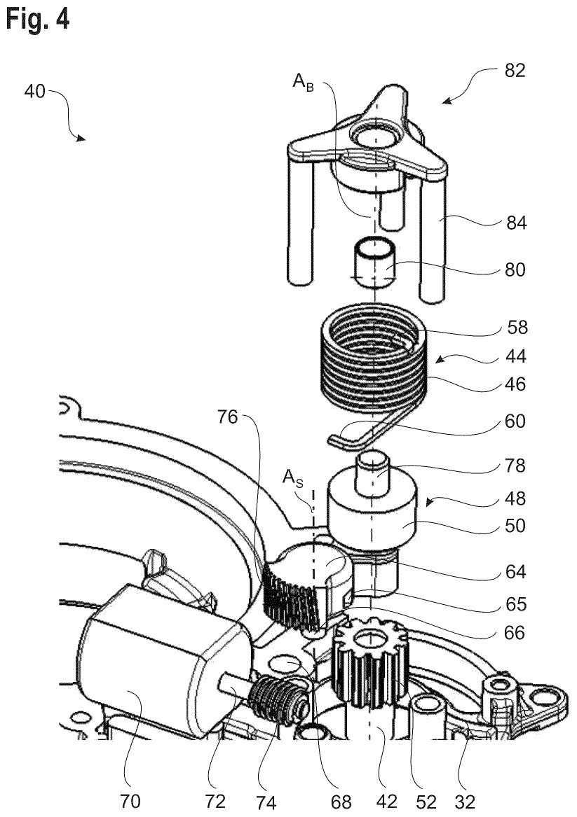

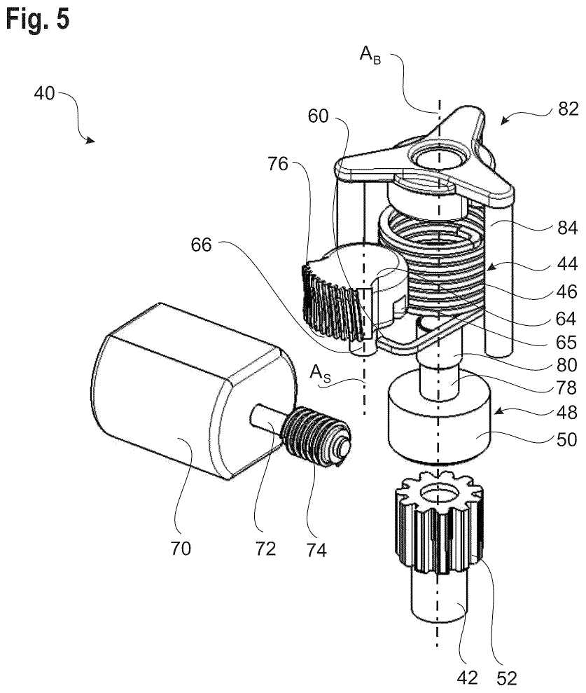

The second free end 60 is fixed to a drive part 64. To this end, in this example it is positively and/or non-positively inserted into a slotted recess 65 on a lower face of the drive part 64 (see for example FIG. 3).

The drive part 64 is rotatably mounted about a centre axis of rotation AS. To this end, the drive part 64 has a circular cylindrical projection 66 which protrudes along the centre axis of rotation AS and which engages in a suitable bearing recess 68 on the housing of the brake actuator 12, here on the frame part 32. The centre axis of rotation AS is parallel to the centre axis of rotation AB of the output shaft 42.

The drive part 64 is coupled to a drive 70. The drive 70 in this example is formed by an electric motor. This electric motor is separate from the electric motor 28, which actuates the vehicle brake 10, and is designed to be significantly smaller and less powerful. For example, it is a miniature DC electric motor.

The drive 70 is electronically connected, for example, via press-in plug contacts to the electronics unit 34, in particular to the conductor tracks of the printed circuit board 38.

In this example, a worm wheel 74 is positioned on a shaft 72 of the drive 70, which worm wheel is in engagement with a toothing 76, in this case a helical toothing, on the drive part 64. It might also be conceivable to connect one or more gear wheels between the shaft 72 and the worm wheel 74 and/or the worm wheel 74 and the drive part 64.

The locking assembly 40 is designed such that the drive part 64 only has to be moved over an angular range of less than 360° in order to tighten the wrap spring 44 from the release position into the locked position. For example, the angular range is 45° to 180°, in particular 90° to 130°.

The toothing 76 is configured on the drive part 64 only over the angular range about which the drive part 64 is actually rotated for activating and releasing the parking brake function.

On the side axially remote from the drive pinion 52 the component 48 has a pin 78 facing along the axis of rotation AB for the bearing arrangement. The pin 78 is rotatably received in a bearing 80 which is fixed to a holding device 82. The holding device 82 has three holding webs 84 which extend parallel to the axis of rotation AB and are fastened to the frame part 32.

Optionally a motor current of the electric motor forming the drive 70 is monitored in order to detect the end positions of the wrap spring 44, i.e. the release position and the locked position. To this end, alternatively or additionally microswitches are optionally provided.

The windings 46 of the wrap spring 44 are wound in this case such that the wrap spring 44 is tightened further when the output shaft 42 rotates in a rotational direction releasing the brake force. If the output shaft 42 rotates in an opposing rotational direction increasing the brake force the wrap spring 44 is loosened.

Since the first end 58 of the wrap spring 44 is connected fixedly in terms of rotation to the output shaft 42 and the second end 60 is connected fixedly in terms of rotation to the drive part 64, a rotation of the drive part 64 (when the output shaft 42 is stationary) which moves the second end 60 away from the windings 46, leads to a tightening of the wrap spring 44 and a reduction in the diameter of the windings 46. Thus the windings 46 firstly bear against the outer surface 50 of the component 48. If the wrap spring 44 is tightened further, the friction between the windings 46 and the outer surface 50 increases. If the frictional force is so high that the output shaft 42 can no longer rotate in the direction releasing the brake force, the locked position of the wrap spring 44 is reached.

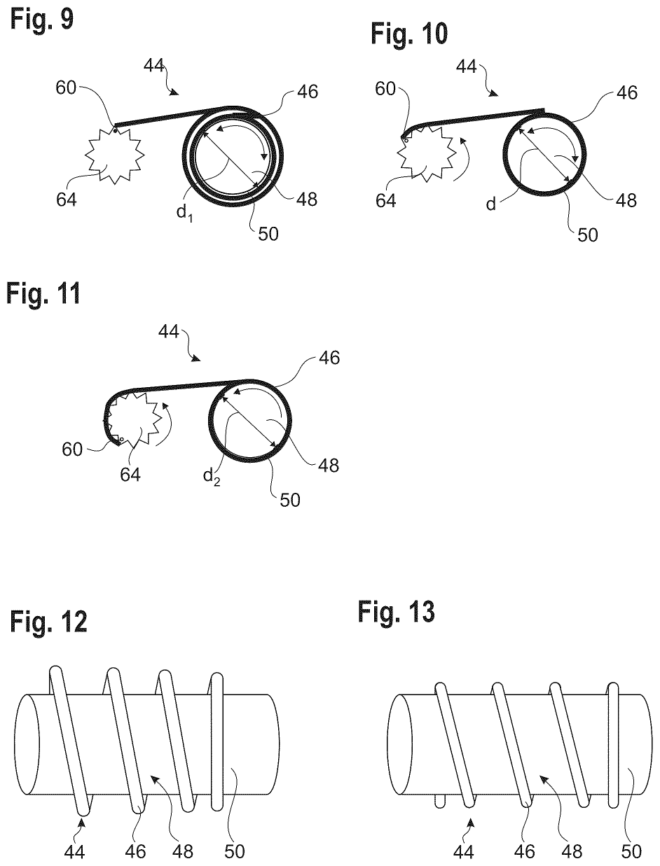

The diameter of the windings 46 varies between a larger first diameter d1 in the release position and a smaller second diameter d2 in the locked position. This is indicated in FIGS. 9 to 11.

The diameter d1 is sufficiently large that in the release position the output shaft 42 is not hindered by the wrap spring 44 and can rotate freely without appreciable frictional losses in both rotational directions (increasing the brake force and releasing the brake force) within the windings 46 of the wrap spring 44.

The diameter d2 is sufficiently small that the frictional forces between the windings 46 and the component 48 are sufficiently large that the output shaft 42 is fully blocked in a rotational direction releasing the brake force. The windings 46 now bear fully against the outer surface 50, so that the diameter d2 corresponds to the diameter of the cylindrical outer surface 50.

This principle is illustrated in FIGS. 9 to 13. In each case the release position of the wrap spring is shown in FIGS. 9 and 12 and the locked position of the wrap spring 44 is shown in FIGS. 11 and 13. FIG. 10 shows an intermediate step during the tightening of the wrap spring 44 with a diameter d of the windings which is between d1 and d2.

In this example the diameter d of the windings 46 changes identically for all windings 46.

The wrap spring 44 consists in this case of a spring wire and is configured such that, without the action of force on the ends 58, 60, it is urged to adopt the larger diameter d1.

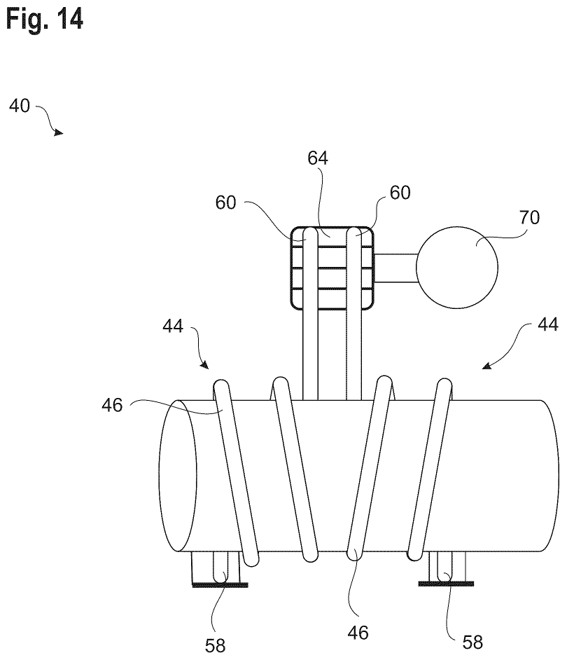

FIG. 14 shows a schematic view of a second variant in which, as a single difference from the above-described embodiment, two parallel wrap springs 44 are wound onto the component 48. The first ends 58 of the wrap springs 44 are fixed in each case to the component, while the second ends 60 are secured to the drive part 64. If hot retensioning is to be possible, both wrap springs 44 have to be wound in the same direction.

The two wrap springs 44 are independent of one another so that the safety of the parking brake function is increased due to the redundancy.

In order to activate the parking brake function, after the vehicle brake 10 is closed the drive 70 is operated and the drive part 64 is rotated by a predetermined angle.

The wrap spring 44 is tightened and the windings 46 reduce their diameter d to the diameter d2 of the locked position.

The friction between the wrap spring 44 and the outer surface 50 of the component 48 is now sufficiently high that the output shaft 42 is completely blocked against a rotation in the rotational direction releasing the brake force.

The electric motor 28 is switched off. Since the worm wheel 74 is self-locking, the drive 70 is now switched off while the wrap spring 44 remains in its locked position.

If the vehicle brake 10 is to be retensioned (hot reclamp) due to the vehicle brake 10 cooling down, while the parking brake function is active, the electric motor 28 of the vehicle brake 10 is actuated in the rotational direction of the output shaft 42 increasing the brake force.

This leads to a simpler release of the wrap spring 44 which makes it possible to rotate the output shaft 42 further in the rotational direction increasing the brake force and thus to increase the tensioning force of the vehicle brake 10.

If the desired brake force of the vehicle brake 10 is reached, the electric motor 28 of the vehicle brake 10 is switched off again. Due to the self-releasing properties of the vehicle brake 10, the output shaft 42 is now urged to rotate in the rotational direction releasing the brake force. However, the wrap spring 44 is tightened again into its locked position according to a rotational angle, which is unimportant for practical reasons, and fully blocks the output shaft 42 again.

The drive 70 remains switched off during the entire hot retensioning process.

For releasing the parking brake function, the drive 70 is operated in the opposing direction and the drive part 64 is rotated in the opposing direction. The second end 60 of the wrap spring 44 moves back in the direction of the output shaft 42. Thus the windings 46 of the wrap spring 44 open again to their first diameter d1 and the wrap spring 44 adopts its release position again.

1. Brake actuator (12) for an electromechanical vehicle brake (10), having an electric motor (28) for actuating the vehicle brake (10) and a locking assembly (40) for selectively rotationally blocking an output shaft (42) of the electric motor (28) to form a parking brake function, wherein the locking assembly (40) comprises a wrap spring (44) and a drive (70), the windings (46) of the wrap spring (44) being arranged coaxially with the output shaft (42) and the locking assembly (40) being configured and arranged such that the drive (70) can tighten the wrap spring (44) about the output shaft (42) into a locked position in order to block the output shaft (42).

2. Brake actuator (12) according to claim 1, wherein the wrap spring (44) adopts a larger first diameter (d₁) in a release position without the action of the drive (70) and a smaller second diameter (d₂) in the locked position, wherein the output shaft (42) can rotate unhindered in the release position of the wrap spring (44) and the output shaft (42) is completely locked in the locked position of the wrap spring at least in a rotational direction releasing the brake force.

3. Brake actuator (12) according to claim 1, wherein the wrap spring (44) is wrapped around an outer surface (50) of a component (48) which is directly arranged on the output shaft (42).

4. Brake actuator (12) according to claim 3, wherein the component (48) is axially positively connected to a drive pinion (52) arranged on the output shaft (42) for driving the vehicle brake (10).

5. Brake actuator (12) according to claim 1, wherein a first end (58) of the wrap spring (44) is fixedly connected to the output shaft (42).

6. Brake actuator (12) according to claim 1, wherein the locking assembly (40) comprises a rotatable drive part (64) which is fixedly connected to a second end (60) of the wrap spring (44) and which is rotated by the drive (70) in order to tighten the wrap spring (44).

7. Brake actuator (12) according to claim 6, wherein a centre axis of rotation (As) of the drive part (64) is parallel to the output shaft (42).

8. Brake actuator (12) according to claim 6, wherein the locking assembly (40) has an electric motor as a drive (70) and a worm wheel (74) coupled to a shaft (72) of the electric motor and the drive part (64) has a toothing (76) which is coupled to the worm wheel (74).

9. Brake actuator (12) according to claim 6, wherein the drive part (64) is rotatably mounted on a frame part (32) of the brake actuator (12).

10. Brake actuator (12) according to claim 1, wherein two wrap springs (44) are arranged parallel to one another along an axis of rotation (A_{B}) of the output shaft (42).

11. Brake actuator (12) according to claim 1, wherein a winding direction of the wrap spring (44) relative to the output shaft (42) is such that in the locked position the wrap spring (44) is expanded by a rotation of the output shaft (42) in a rotational direction increasing the brake force and is tightened again in an opposing rotational direction releasing the brake force.

12. Brake actuator (12) according to claim 1, wherein the electric motor (28) is coupled in terms of drive via a gear unit (30) and a spindle drive (22) to an actuating carriage (26) which can be selectively moved between a retracted position and an extended position in order to apply a brake pad (20) to a brake rotor (18).

13. Method for operating a brake actuator (12) of an electromechanical vehicle brake (10) according to claim 1, having the steps:
closing the electromechanical vehicle brake (10),
activating the drive (70) and tightening the wrap spring (44) as far as the locked position so that the output shaft (42) is blocked,
rotating the output shaft (42) by the electric motor (28) in a rotational direction increasing the brake force, whereby the wrap spring (44) is loosened,
re-setting the vehicle brake (10) by the electric motor (28) in the rotational direction increasing the brake force, and
releasing the output shaft (42) by switching off the electric motor (28), whereby the wrap spring (44) is tightened again.
